(19) United States
(12) Patent Application Publication
(10) Pub. No.: US 2011/0080481 A1
(43) Pub. Date: Apr. 7, 2011

(54) Automobile Rear View Mirror Assembly for Housing a Camera System and a Retractable Universal Mount

(76) Inventor: DAVID W. BELLINGHAM, Calgary (CA)

(21) Appl. No.: 12/573,728

(22) Filed: Oct. 5, 2009

(51) Int. Cl. H04N 7/18

(52) U.S. Cl. 348/148

(57) ABSTRACT

A rear view mirror assembly comprises a body having cameras for viewing and recording images out the front windshield and the rear window of the vehicle. The rear-facing cameras can be used to record the activities of the driver while driving and the activities of any rear-seated passengers. The cameras are connected to a camera system that may comprise means for camera control, power and recording and may be included in the body. The body may also have a GPS receiver. The body further includes a retractable universal mounting bracket used for mounting portable electronic devices having display screens. The display screen can be used to display images recorded by the cameras and GPS data such as street maps and vehicle location.

### FIELD OF THE INVENTION

This invention relates to the field of land vehicles and more particularly to their accessories, namely, mirrors, and specifically to an automobile rear view mirror assembly for housing a camera system and a retractable universal mount.

### BACKGROUND OF THE INVENTION

All modern vehicles are equipped with a rear view mirror. Generally, the rear view mirror is housed in an assembly that is fixed to the windshield of the vehicle with a ball and socket joint for personal adjustment. Vehicles such as police cars, taxi cabs and other commercial vehicles are often further equipped with cameras to record the operating environment of the vehicle. For example, a police car may, for evidentiary purposes, record situations taking place outside the police car through the front windshield and rear window. Such a situation might be a high-speed chase, where recording the perpetrator in action is important to a successful conviction. In another example, a taxi cab may wish to record the identity of the occupants of the cab for the purposes of deterring criminal acts and recording any criminal acts that do take place. In yet another example, a driver training school may wish to record the training sessions of a student for critique. Most automotive camera systems include camera elements mounted on the dash board of the automobile or in the front upper corner of the driver's or passenger's side. These positions obscure the driver's front windscreen vision and are not aesthetically pleasing. As well, they do not readily permit the clandestine monitoring of driver training students or taxi cab passengers.

Automobile global positioning systems and other electronic devices such as satellite radios and mobile phones also have the same disadvantages as automobile camera systems. Their components are either mounted on the dashboard or to the console of the vehicle. This creates further visual impairments for the driver and clutters the instrumentation of the vehicle.

Various rear mirror assemblies have included a variety of electronic and mechanical elements in their designs such as radio antennae, compasses and illumination lamps. However, the rear view mirror assembly is well positioned within the vehicle to include a camera system for front and rear viewing. As well, the mirror assembly can house a retractable universal mount for holding a variety of portable electronic devices such as global positioning system devices and cellular telephones. The positioning of these devices on the universal mount makes for safe and ergonomic operation of these devices without having to clutter the instrument panel with ad-hoc accessory attachments.

What is therefore required is a rear view mirror assembly that includes a camera system for rear and front viewing as well as a retractable universal mount for holding a variety of portable electronic devices.

### SUMMARY OF THE INVENTION

In one embodiment of the invention there are four cameras located in the mirror assembly. These cameras they cover a full 360 degrees on a horizontal plane and 180 degrees on the vertical plane. The cameras are modern CCD day & night colour cameras with high resolution. The cameras have self-regulating exposure control. A microphone is located in the housing to allow for audio recording. The cameras can record data to a DVR unit installed in the mirror assembly on a continuous 24 hour loop. This will allow for playback to an event and after. The cameras and microphones can be recorded simultaneously on separate channels to a DVR unit installed within the assembly. The recording will have real time and date stamp as well as a programmed Vehicle Identification Number according to a specific vehicle. Encryption software embedded in the DVR unit will allow only authorized users to view information gathered by the cameras microphone or other elements. A USB port or digital SDD card, will allow for the transfer of information from the camera system installed in the mirror assembly to an external storage unit or other device. The DVR or recording system will also record other elements in real time to correlate with the cameras data such as vehicle speed, acceleration and deceleration data when hardwired to the vehicles computer and other systems. The mirror assembly also includes a retractable universal mounting bracket for mounting a variety of portable electronic devices which can interact with the camera system. Examples of such devices are Global Positioning System receivers and display units, portable telephones and satellite radio receivers. The universal mounting bracket will support connections from devices on the universal mount to the automobile power system as well as connections to the camera system installed in mirror assembly. For example, the bracket may mount a GPS unit and support its functionality such as touch screen, text to speech and voice guidance. The retractable mount moves up and down with the press of a button mounted on the front panel of the mirror assembly accessible to the driver. The retractable bracket is actuated by a motor driven slide and screw mechanism. Using the retractable universal mounting bracket for mounting portable devices allows for a less obstructed view for passengers and drivers thereby adding to safety. The mirror assembly can either be hardwired to the vehicles power system with a wiring system or operate through a car lighter/auxiliary power system. In other embodiments of the invention it is possible to integrate a vehicles security system and or add sensors for theft deterrent when system is hardwired to vehicle system. This will activate the camera system and event recording. The mirror assembly camera system permits 24 hour continuous recording even while vehicle is parked or not in use. Sensors and triggers located within the system will actuate system recording. The electrical draw from the invention is minimal and therefore would only require the vehicle to be started once every 2-3 weeks to charge car battery system.

In one embodiment of the invention, the camera system is self aware and errors in the camera system will appear on any device with a screen connected to the camera system. The system diagnostics will instruct operators to make changes or corrections to the system to assure correct functioning of the overall system.

In another embodiment of the invention software can be installed within the operating system of the DVR unit to allow encryption of recorded data for playback only by authorized persons.

The mirror assembly camera system allows for the monitoring of employees during working hours to ensure that safe driving habits are followed and that the vehicle is properly operated and maintained.

In yet another embodiment of the invention, the drop down GPS or retractable universal mount will be on a swivel mechanism allowing for the correct orientation of the mirror assembly while at the same time the correct orientation of the GPS unit or other device for driver or passenger viewing.

In another embodiment of the invention there is provided a rear view mirror assembly that includes a camera system for viewing a student driver undergoing driver training.

In yet another embodiment of the invention there is provided a rear view mirror assembly that includes a camera system for viewing the rear-seated passengers in an automobile such as in a taxi cab.

In another embodiment of the invention there is provided a rear view mirror assembly which includes a global positioning system display screen which has a deployed position for viewing and a retracted position for storage within the rear view mirror assembly.

These and other features and advantages of my invention will be further appreciated by those skilled in the art by reference to the following drawings and description.

### ADVANTAGES AND OBJECTIVES OF THE INVENTION

One objective of the present invention is to make individual drivers more accountable when driving motor vehicles.

Another objective of the present invention is to reduce high risk behaviour when driving such as speeding and tailgating. This should in-turn reduce vehicle related deaths, injury and damages.

Another objective of the present invention is to provide recorded data for the purpose of legal proceedings and prosecution as it relates to traffic violations as well as crimes such as assaults on commercial drivers and truck high-jacking.

Yet another objective of the present invention is to discourage criminal activity such as vandalism, hit and runs and vehicle theft and high risk driving practices.

One advantage of the present invention is that the integration of a universal retractable mount permits the addition of a navigation system and other electronic devices and operation of these devices with multiple functions including hands free cell phone use, text to speech with voice guidance and blue tooth capabilities.

Another advantage of the present invention is that it permits the integration of a GPS unit or other device into the mirror assembly with far less obstructed view out of the front windshield.

The GPS technology can be integrated with the assembly's camera system.

### BRIEF DESCRIPTION OF THE DRAWINGS

FIG. 1 is a top view of one embodiment of the invention including front and rear facing cameras.

FIG. 2 is a side view of the embodiment shown in FIG. 1.

FIG. 3 is a front view of the embodiment shown in FIG. 1.

FIG. 4 is a front perspective view of the embodiment shown in FIG. 1.

FIG. 5 is a bottom view one embodiment of the invention illustrating a global positioning system display screen in a retracted position.

FIG. 6 is a front view of one embodiment of the invention illustrating a global positioning system display screen in a deployed position.

FIG. 7 is a front perspective view of the embodiment shown in FIG. 6.

FIG. 8 is a side view of the embodiment shown in FIG. 6.

FIG. 9 is a bottom view of the embodiment shown in FIG. 6 showing a global positioning system display screen in a deployed position.

FIG. 10 is a front view of one embodiment of the invention having a retractable universal mounting bracket.

FIG. 11 is a front perspective view of the embodiment shown in FIG. 10.

FIG. 12 is a top view of the embodiment shown in FIG. 10.

FIG. 13 is a right-side view of the embodiment shown in FIG. 10.

FIG. 14 is a bottom view of the embodiment shown in FIG. 10.

FIG. 15 is a view of two samples of adapters used for mounting a variety of portable electronic devices to retractable universal mounting bracket of one embodiment of the invention.

### DETAILED DESCRIPTION

### Retractable GPS Screen

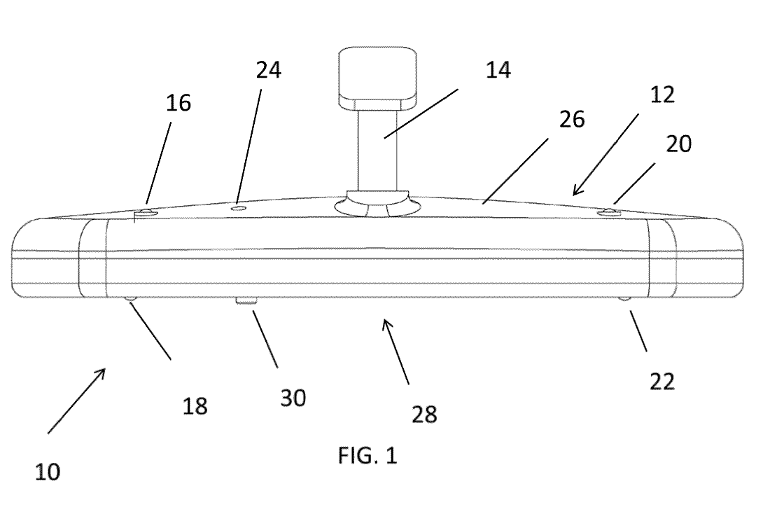

Referring to FIG. 1 and in accordance with one embodiment of the present invention there is shown a top view of a rear view mirror assembly 10 for a vehicle. The mirror assembly 10 comprises a body 12, a mirror mounting member 14, at least one camera 16 having a forward orientation for capturing exterior images forward of the vehicle and at least one camera 18 having a rearward orientation for capturing exterior images rearward of the vehicle. In the embodiment illustrated there is a second forward oriented camera 20 for redundancy and for potential stereoscopic image recording. There is also a second rearward oriented camera 22 which can be used for obtaining images of the driver or for recording images of passengers situated in the back seat of the vehicle. Combined, the cameras are able to provide 360 degree coverage around the vehicle as well as up to 180 degrees above and below the horizontal. Shown at 30 is a button control for deploying the global positioning system display screen from a first receiving area of the body as more fully explained below.

In one embodiment the cameras mounted to the body are part of a camera system mounted within a second receiving area within the body. The camera system comprises the four cameras, a microphone a digital recorder for recording images audio and other elements, a camera controller and power supply and 2 USB cords for electronic interface with vehicle and other devices located on the retractable universal mount. Power supply includes both battery power (DC) mounted within the body and a USB adapter for plugging the body into an existing wiring harness, hardwired to the vehicles power supply or another DC socket such as the cigarette/auxiliary power supply.

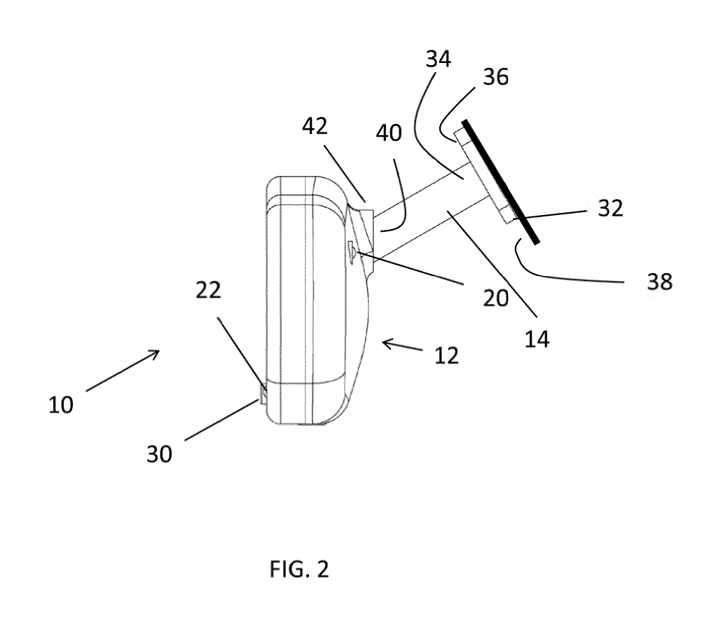

Referring to FIG. 2 there is shown a side view of an embodiment of the rear view mirror assembly 10. The body 12 of the mirror assembly is suspended from the mirror mounting member 14 and is oriented downwards from the windshield 32 to a position that is ergonomically ideal for rear viewing and hand adjustment by the driver. The front end 34 of the mirror mounting member 14 includes a mounting pad 36 that is used for adhesively mounting the member to the inside surface 38 of the windshield. The rearward end 40 of the mirror mounting member 14 includes mounting means 42 for mounting the body 12 of the mirror assembly 10 to the mounting member. Mounting means 42 is typically a swivel mount to permit easy hand adjustment of the rear view mirror by the driver. Camera 20 is illustrated oriented forward and camera 22 is illustrated oriented rearward. The global positioning system screen deployment button is also illustrated. The body is locked to the mirror mounting member for theft deterrence.

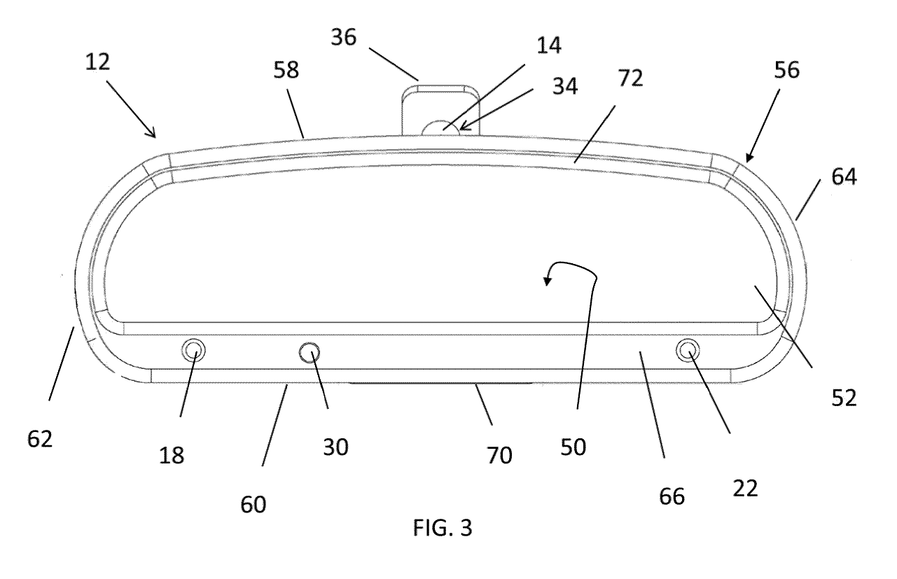

Referring now to FIG. 3 there is shown a front view of the invention 10 illustrating the front face 50 of the body 12, the windshield mounting pad 36 and the forward end 34 of the mirror mounting member 14. The reflective mirror element 52 is mounted on the front face 50 of the body 12 in a recessed manner. The body 12 of the mirror assembly comprises a periphery 56 a top surface 58, a bottom surface 60, a left side surface 62 and a right side surface 64. The front face 50 of the body 12 further includes a front panel 66 in which camera 18 and camera 22 are mounted as well as global positioning system display screen deployment button 30. The bottom of the rectangular global positioning system display screen or retractable universal mount 70 can be seen protruding slightly from the bottom surface 60 of the body 12. The peripheral surface 56 of the assembly body 12 may be aesthetically moulded as a single piece with moulded element 72 used to retain the mirror 52 in position. The front panel can be used to mount other control devices for additional portable devices that may be mounted in the body such as mobile phone devices.

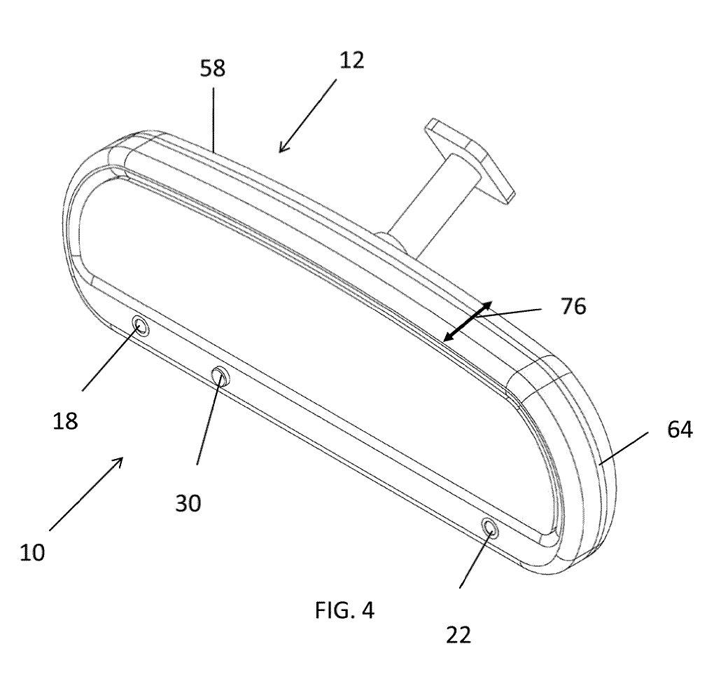

Referring to FIG. 4 there is shown a front perspective view of the body 12 of the invention 10 illustrating top surface 58 and right side surface 64. The body 12 has a width 76 that is adequate to accommodate a first receiving space for the global positioning display screen and its plurality of deployment/retraction mechanisms as well as a second receiving space for the camera system described above. Rearward oriented cameras 18 and 22 are shown with button 30 for deploying and retracting the global positioning system display screen.

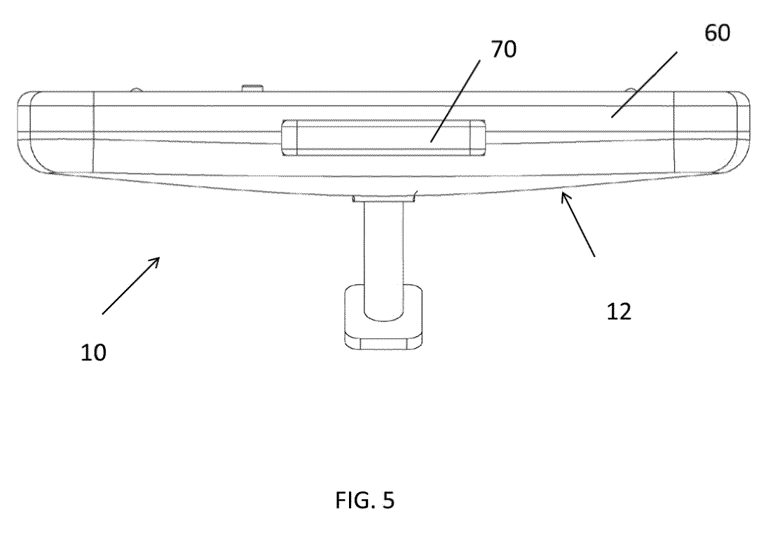

Referring to FIG. 5 there is shown a bottom view of the body 12 of the invention 10. Bottom surface 60 is shown with the global positioning system display screen or retractable universal mount 70 shown in a retracted position.

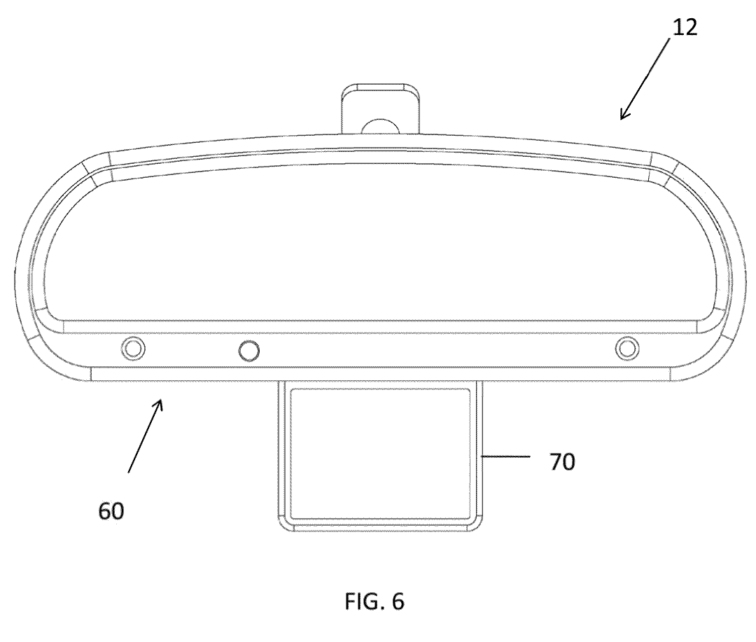

Referring to FIG. 6 there is shown a front view of the body 12 of the invention 10 in which the global positioning system display screen 70 is shown in a deployed configuration. The screen 70 is centrally mounted in the bottom surface 60 of the body 12 and is generally rectangular in shape and sufficiently sized to provide the driver with useful information clearly displayed. The screen can be swivelled about an axis so that the driver and passenger can adjust the orientation of the screen. The screen may also be detached from the mirror assembly. The GPS display screen and GPS signal receiving system can be integral to the mirror assembly. In another embodiment of the invention described below the GPS display screen is which is removable and attached to a retractable universal mounting bracket as more fully described below.

In other embodiments of the invention the display screen is replaceable by a retractable universal mounting bracket for mounting other devices such as a smart phone, satellite radio or an after-market brand of GPS device. These add-on devices can be attached to the retractable universal mount and the mount will include a suitable electrical interface for powering the devices.

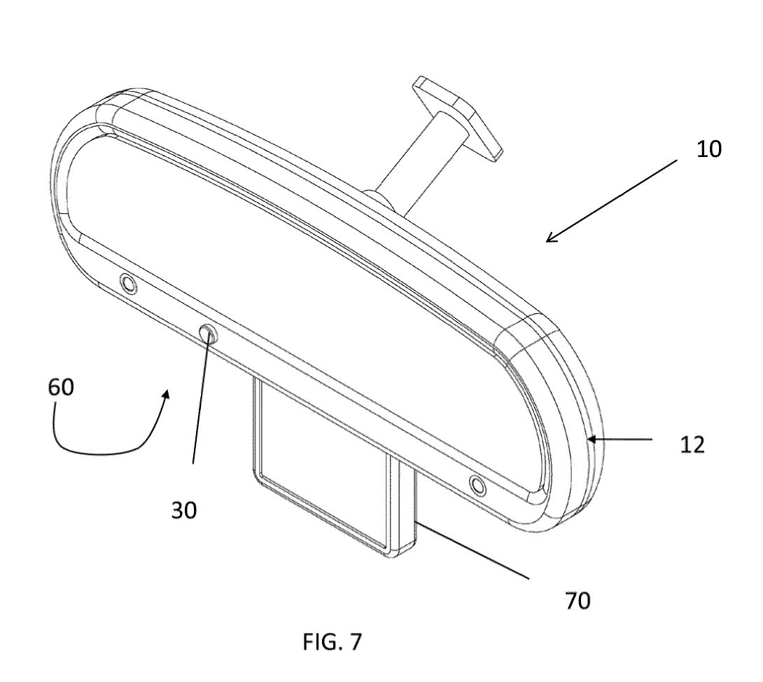

Referring to FIG. 7 there is shown a front perspective view of the body 12 of the invention 10 in which the global positioning system display screen 70 is deployed from the bottom surface 60 of the body. Actuation of the display screen deployment/retraction mechanism is by button 30.

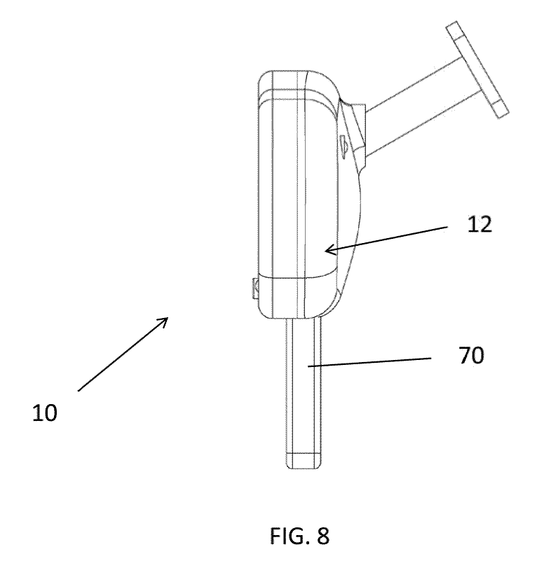

Referring to FIG. 8 there is shown a side view of the body 12 of the invention 10 in which the global positioning system screen or retractable universal mount 70 is deployed.

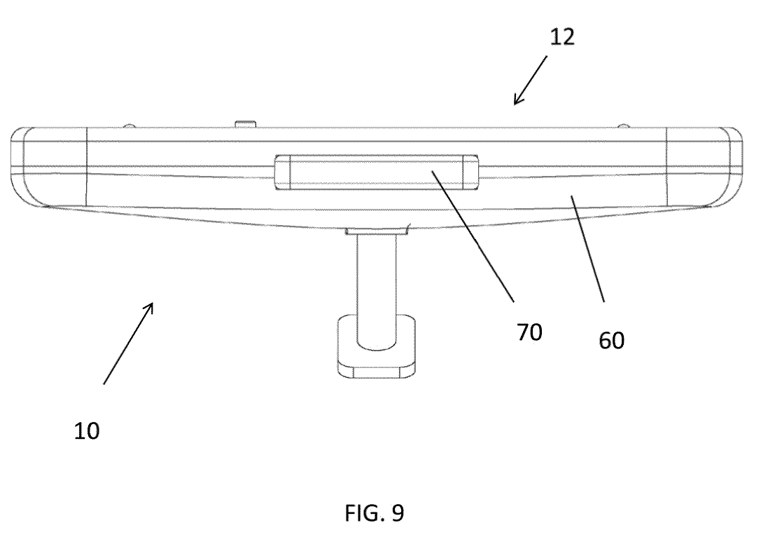

Referring to FIG. 9 there is shown a bottom view of the body 12 of the invention 10 in which the global positioning system screen or retractable universal mount 70 is deployed from the bottom surface 60.

### Retractable Universal Mounting Bracket

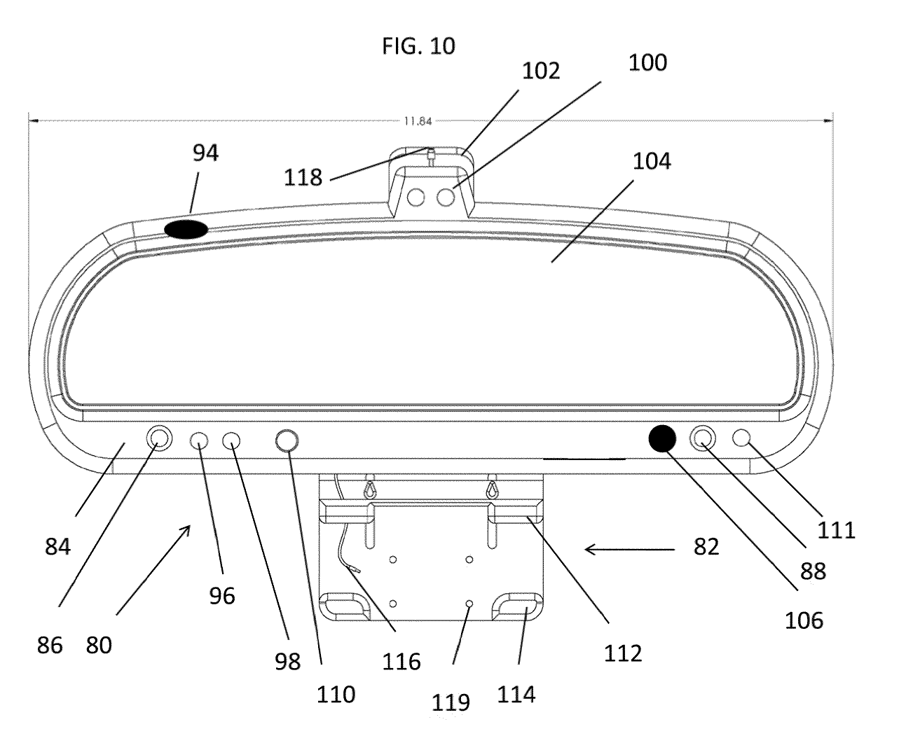

Referring to FIG. 10 there is shown another embodiment of the invention 80 in which the retractable screen has been replaced with a retractable universal mounting bracket 82 adapted to carry a variety of electronic devices including a GPS device. The mirror assembly 80 includes front panel 84 and the following devices: left mounted rear facing CCD camera 86 mounted on the panel 84; right mounted rear facing CCD camera 88 mounted on the panel 84; left mounted front facing CCD camera 90 (not shown); right mounted front facing CCD camera 92 (not shown); microphone 94 for recording audio onto a camera system; Buttons 96 and 98 are part of a hands free communication system that operates via Bluetooth or similar technology. Microphone 100 allows for voice recognition and hands free speech. Button 96 is the phone button that allows for connection of phone to system and button 98 a voice recognition button that allows for interaction with the hands free communication system and in the overall functioning of the system. This system can be hardwired via 118 to the audio and other vehicle systems or operate through a radio signal to the vehicles audio system attachment pad 102 for attaching the assembly to the inside surface of the front windshield; mirror 104 which may also be an automatic dimming mirror using photochemical means; rear facing light sensor 111 and front facing light sensor 108 (not shown) for sensing light in order to activate the dimming mirror photochemical means by electrically charging the photochemical means between two plates of glass in the mirror 104; mirror dimming button 106; mounting bracket deploy/retract button 110; removable and adjustable upper mounting bracket 112 for adjusting to the size of the electronic device on the universal bracket; fixed lower mounting bracket 114; USB attachment cord 116 for connecting the camera system within the assembly to the device mounted on the bracket as well as power supply to the device on the retractable universal mount; a USB attachment cord 118 for connecting the mirror assembly and its devices to the automobile power system, for example, through the automobile cigarette/auxiliary power supply and also allows for electronic interface between other vehicle systems and housing systems, example: when the security system of the vehicle is activated the camera system will actuate and record events. Apertures 119 are included in the universal mounting bracket 82 to fix adapter brackets to the universal mounting bracket so that various brands and designs of electronic device can be attached to the universal mounting bracket. The adapter brackets are described below.

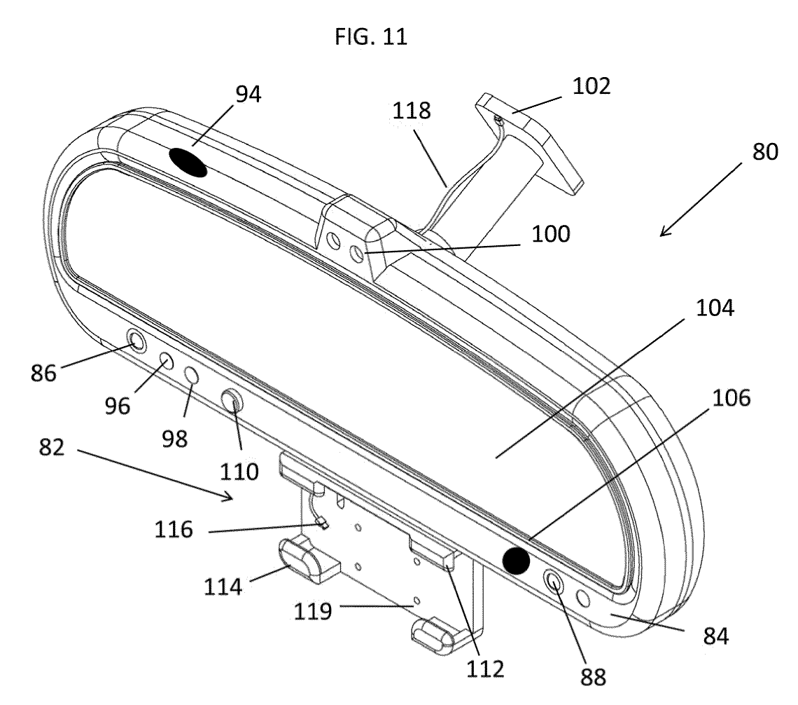

Referring to FIG. 11, there is a front perspective view of the embodiment shown in FIG. 10. The following components are illustrated: The mirror assembly 80 includes retractable universal mounting bracket 82 and front panel 84. The following devices are mounted on the assembly 80: left mounted rear facing CCD camera 86; right mounted rear facing CCD camera 88; left mounted front facing CCD camera 90 (not shown); right mounted front facing CCD camera 92 (not shown); Buttons 96, 98 and microphone 100 are part of a hands free communication system that operates via Bluetooth or similar technology. Microphone 100 allows for voice recognition and hands free speech. Button 96 is the phone button that allows for connection of phone to system and button 98 a voice recognition button that allows for interaction with the hands free communication system and in the overall functioning of the system. This system can be hardwired via 118 to the audio and other vehicle systems or operate through a radio signal to the vehicles audio system; attachment pad 102 for attaching the assembly to the inside surface of the front windshield; mirror 104 which may also be an automatic dimming mirror using photochemical means; rear facing light sensor 84 and front facing light sensor 108 (not shown) for sensing light in order to activate the dimming mirror photochemical means by electrically charging the photochemical means between two plates of glass in the mirror 104; mirror dimming button 106; mounting bracket deploy/retract button 110; removable and adjustable upper mounting bracket 112; fixed lower mounting bracket 114; USB attachment cord 116 for connecting the camera system within the assembly to the device mounted on the bracket as well as power supply to the device on the retractable universal mount; a USB attachment cord 118 a USB attachment cord for connecting the mirror assembly and its devices to the automobile power system, for example, through the automobile cigarette/auxiliary power supply and also allows for electronic interface between other vehicle systems and housing systems, Apertures 119 in the universal mounting bracket 82 are used to fix adapter brackets to the universal mounting bracket so that a variety of brands and styles of devices can be attached to the mounting bracket.

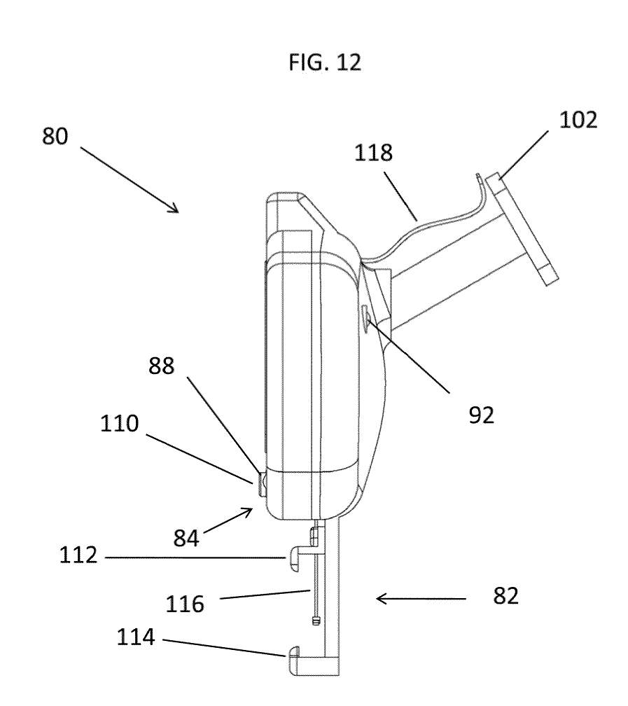

Referring now to FIG. 12, there is shown a right-side view of the mirror assembly: The mirror assembly 80 includes the retractable universal mount 82 and front panel 84. FIG. 12 illustrates right mounted rear facing CCD camera 88 and right mounted front facing CCD camera 92. Attachment pad 102 attaches the assembly to the inside surface of the front windshield. Mounting bracket deploy/retract button 110 is shown protruding from the front panel 84. The retractable universal mounting bracket includes adjustable upper mounting bracket 112 and fixed lower mounting bracket 114. USB attachment cord 116 is used to connect the camera system within the assembly to the device mounted on the retractable universal mount as well as power supply to the device on the retractable universal mount and power connection cord 118 a USB attachment cord for connecting the mirror assembly and its devices to the automobile power system, for example, through the automobile cigarette/auxiliary power supply and also allows for electronic interface between other vehicle systems and housing systems,

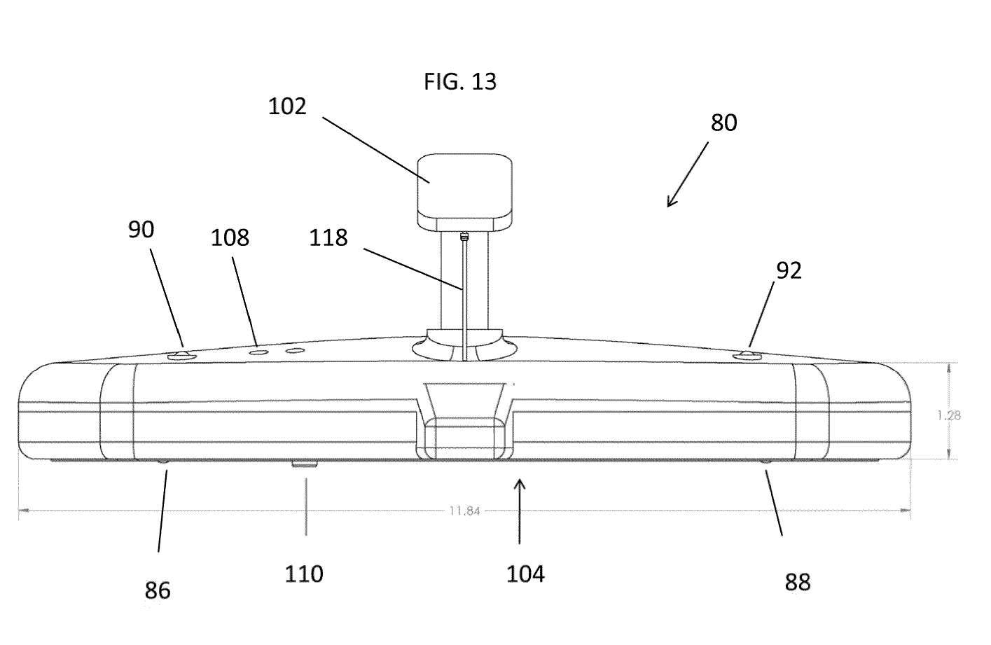

Referring to FIG. 13 there is shown a top view of the mirror assembly 80 illustrating the following items: left mounted rear facing CCD camera 86; right mounted rear facing CCD camera 88; left mounted front facing CCD camera 90 and right mounted front facing CCD camera 92. Note the microphone 100 which is a part of the hands free communication system a part of assembly 80. Attachment pad 102 is used for attaching the assembly to the inside surface of the front windshield. Front facing light sensor 108 is for sensing light in order to activate the dimming mirror photochemical means by electrically charging the photochemical means between two plates of glass in the mirror 104 a USB attachment cord 118 for connecting the mirror assembly and its devices to the automobile power system, for example, through the automobile cigarette/auxiliary power supply and also allows for electronic interface between other vehicle systems and housing systems,

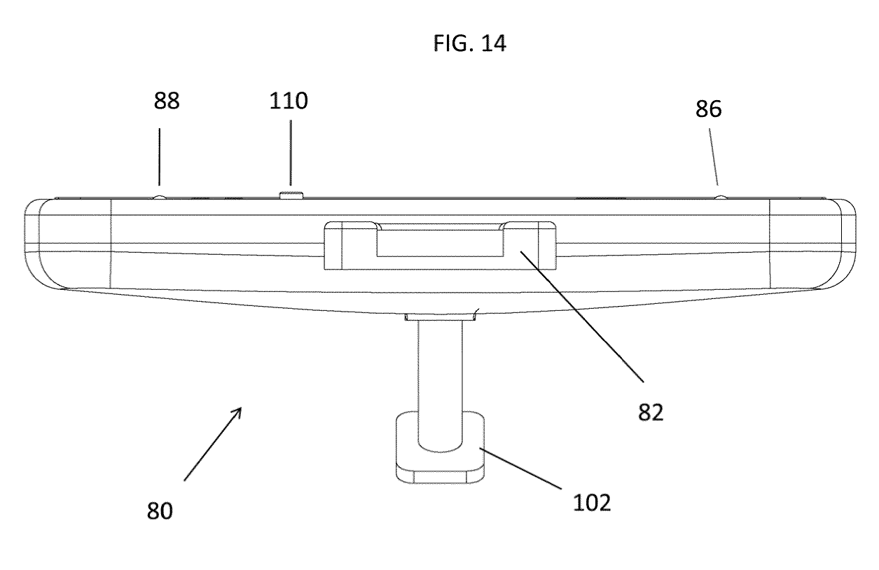

FIG. 14 illustrates a bottom view of the mirror assembly in which the mirror assembly 80 includes universal bracket 82, left mounted rear facing CCD camera 86 and right mounted rear facing CCD camera 88. Attachment pad 102 is shown and is used for attaching the assembly to the inside surface of the front windshield.

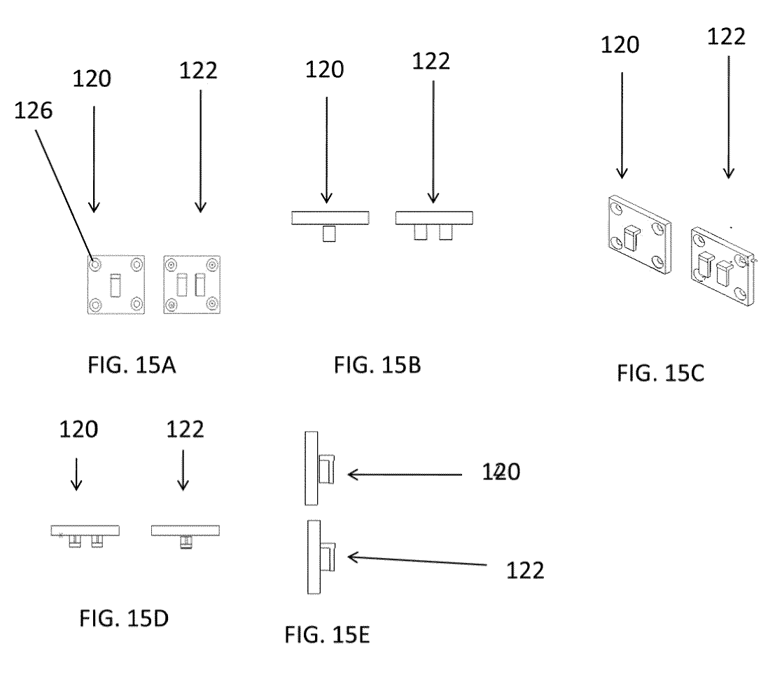

FIG. 15 illustrates samples of mounting clips 120, 122 and 124 which are intended to be attached to the retractable mounting bracket. They would be attached to the mounting bracket by four screws through the apertures 126 shown.

Changes and modifications to the specifically described embodiments may be carried out without departing from the principles of the present invention which is intended to be limited only by the scope of the appended claims.

What is claimed is:

1. An automobile rear view mirror assembly for housing a camera system and a retractable display screen wherein said assembly comprises a body having a first receiving space centrally disposed therein, said receiving space provided to receive said display screen and a plurality of deployment/retraction mechanical elements for moving the display screen into and out of said body, and wherein said camera system comprises at least one forward oriented camera disposed on a front-facing surface of the body for capturing images of the environment outside of the front of the vehicle, at least one rearward oriented camera disposed on a rear-facing surface of the body for capturing the images of the environment outside the rear of the vehicle, and wherein the display screen is operatively connected to said at least one forward and rearward oriented cameras for displaying said camera images.

2. The assembly of claim 1 wherein the camera system further comprises a camera controller, digital image recorder, microphone and power supply and wherein the body further includes a second receiving space disposed therein for receiving said controller, recorder and power supply.

3. The assembly of claim 2 wherein the camera system further comprises at least two forward oriented cameras disposed on said front-facing surface of the body and at least two rearward oriented cameras disposed on said rear-facing surface of the body, wherein said at least two front-facing and rear-facing cameras are operatively connected to the display screen.

4. The assembly of claim 3, wherein said means for camera control, camera image recording and camera power are disposed outside of the body and operatively connected to the at least two front-facing and rear-facing cameras.

5. The assembly of claim 1 further comprising a mirror mounting member for mounting the body to an inside surface of a front windshield and within easy manual manipulation of a driver.

6. The assembly of claim 5 wherein said mirror mounting member comprises a front end fixed to a windshield mounting pad for adhesive mounting to said front windshield inside surface and a rear end having a swivel mount for mounting the body, said swivel mount permitting body adjustment by said driver.

7. The assembly of claim 1 further comprising a reflecting mirror mounted to the rearward face of the body.

8. The assembly of claim 1 wherein the rear-facing surface of the body further comprises a panel mounting the at least one rear-facing camera and a button for actuating deployment and retraction of the display screen.

9. The assembly of claim 1, further comprising an operative connection to a global positioning system wherein the retractable display screen displays data received from said global positioning system.

10. An automobile rear view mirror assembly for housing a camera system, a global positioning system receiver and a retractable display screen wherein, said assembly comprises a body having a first receiving space centrally disposed therein, said first receiving space provided to receive said display screen and a plurality of deployment/retraction mechanical elements for moving the display screen into and out of said body, a second receiving space disposed therein for receiving a camera system and a third receiving space disposed therein for receiving a global positioning system receiver, wherein the display screen displays images received from said camera system and said global positioning system receiver.

11. The assembly of claim 10 wherein said camera system comprises at least one forward oriented camera disposed on a front-facing surface of the body for capturing images of the environment outside of the front of the vehicle, at least one rearward oriented camera disposed on a rear-facing surface of the body for capturing the images of the environment outside the rear of the vehicle, and wherein the display screen is operatively connected to said at least one forward and rearward oriented cameras for displaying said camera images.

12. The assembly of claim 11 wherein the at least one forward and rearward oriented cameras are digital cameras.

13. The assembly of claim 12 wherein the rear-facing surface of the body includes a panel and a display screen deployment and retraction actuating button disposed thereupon.

14. An automobile rear view mirror assembly for housing a camera system and a retractable universal mounting bracket for mounting a portable electronic device having a display screen, wherein said assembly comprises a body having a first receiving space centrally disposed therein, said first receiving space provided to receive said retractable universal mounting bracket and a plurality of deployment/retraction mechanical elements for moving the universal mounting bracket into and out of said body, a second receiving space for housing said camera system, and wherein said camera system comprises at least one forward oriented camera disposed on a front-facing surface of the body for capturing images of the environment outside of the front of the vehicle, at least one rearward oriented camera disposed on a rear-facing surface of the body for capturing the images of the environment outside the rear of the vehicle, an image recorder/DVR a microphone, a camera controller and a power supply.

15. The assembly of claim 14 wherein the retractable universal mounting bracket further includes a USB connecting cord for operatively connecting the portable device mounted to the universal mounting bracket to the camera system and to provide power so that said display screen displays images recorded by the camera system.

16. The assembly of claim 15 wherein the retractable universal mounting bracket further includes an adjustable upper moving bracket and a fixed lower bracket for mounting the portable device.

17. The assembly of claim 16 wherein the retractable universal mounting bracket includes a plurality of adapter brackets that can be removable or fixed to the universal mounting bracket for mounting a variety of electronic devices wherein said plurality of adapter brackets include surface topography in alignment with the surface topography of the electronic device so that the electronic device sits tightly in the universal mounting bracket.

18. The assembly of claim 17 wherein the electronic device is a cellular phone with or without GPS Applications.

19. The assembly of claim 18 wherein the electronic device is a satellite radio unit.
